(19) United States
(12) Patent Application Publication
(10) Pub. No.: US 2026/0261037 A1
(43) Pub. Date: Sep. 3, 2026

(54) V-SHAPED ANTENNA AND COMMUNICATION SYSTEM

(71) Applicant: HUAWEI TECHNOLOGIES CO., LTD., Shenzhen (CN)

(72) Inventors: Shijie Cai, Shenzhen (CN); Chen Hu, Beijing (CN); Yihong Wang, Beijing (CN); Kunpeng Liu, Beijing (CN)

(73) Assignee: HUAWEI TECHNOLOGIES CO., LTD., Shenzhen (CN)

(21) Appl. No.: 19/661,224

(22) Filed: Apr. 28, 2026

Related U.S. Application Data
(63) Continuation of application No. PCT/CN2024/118078, filed on Sep. 10, 2024.

(30) Foreign Application Priority Data
Oct. 31, 2023 (CN) 202311438423.7

(51) Int. Cl. H01Q 1/24; H01Q 1/36; H01Q 21/00

(52) U.S. Cl. CPC H01Q 1/246; H01Q 1/36; H01Q 21/00

(57) ABSTRACT

A V-shaped antenna and a communication system are disclosed. The system includes a mounting bracket and at least two antennas, and the at least two antennas are mounted on the mounting bracket around a periphery of the mounting bracket. The at least two antennas include a V-shaped antenna. The V-shaped antenna includes two mounting plates. A radiating element array is mounted on a surface of a side that is of each mounting plate and that is away from the mounting bracket, and planes on which the two mounting plates are located intersect, to form a V-shaped structure. One of the two mounting plates has a first axis, the other mounting plate has a second axis, and the first axis and the second axis are perpendicular to a center line extending along an axis of the mounting bracket.

### CROSS-REFERENCE TO RELATED APPLICATIONS

This application is a continuation of International Application No. PCT/CN2024/118078, filed on Sep. 10, 2024, which claims priority to Chinese Patent Application No. 202311438423.7, filed on Oct. 31, 2023. The disclosures of the aforementioned applications are hereby incorporated by reference in their entireties.

### TECHNICAL FIELD

This application relates to the field of communication technologies, and in particular, to a V-shaped antenna and a communication system.

### BACKGROUND

With development of wireless communication technologies, a communication system is capable of supporting more communication frequency bands. Therefore, an antenna structure of the communication system is more complex, and an antenna integrity is also higher. However, due to limitations imposed by factors such as wind load, it is difficult to further increase a front size of the antenna. This results in a small quantity of radiating elements integrated into the antenna, which restricts strength and a range of a signal that may be radiated, making it difficult to improve performance of the communication system.

### SUMMARY

This application provides a V-shaped antenna and a communication system, to optimize a relationship between a frontal area and a radiation area, and adjacent V-shaped antenna brackets are less prone to signal blocking, thereby helping improve a gain of the communication system.

According to a first aspect, this application provides a communication system. The communication system includes a mounting bracket and at least two antennas, and the at least two antennas are mounted on the mounting bracket around a periphery of the mounting bracket, to cover a region on the periphery of the mounting bracket. The at least two antennas include a V-shaped antenna. For example, a part of the at least two antennas may be the V-shaped antenna, or all of the at least two antennas are V-shaped antennas. The V-shaped antenna includes two mounting plates. A radiating element array is mounted on a surface of a side that is of each mounting plate and that is away from the mounting bracket, and planes on which the two mounting plates are located intersect, to form a V-shaped structure. A first included angle exists between the first mounting plate and the second mounting plate. Specifically, one of the two mounting plates has a first axis, the other mounting plate has a second axis, and the first axis and the second axis are perpendicular to a center line extending along an axis of the mounting bracket. A first included angle β exists between the first axis and the second axis, and the first included angle β is less than or equal to 150°. The V-shaped antenna occupies a small area of a frontal area, and a large quantity of radiating elements may be arranged, thereby maximally optimizing a relationship between the frontal area and a radiation area. In addition, adjacent V-shaped antenna brackets are less prone to signal blocking, thereby helping improve a gain of the communication system.

In one embodiment, an angle of the first included angle β may be 60° or 120°. In this way, blocking between adjacent antennas may be maximally reduced, thereby helping improve the gain of the communication system, and helping implement coordination between different V-shaped antennas in the communication system, to serve different cells.

Specifically, areas of the two mounting plates of one V-shaped antenna are the same, thereby helping simplify a design of the V-shaped antenna and control of a radiation signal.

In a state in which the V-shaped antenna is mounted on the mounting bracket, two mounting plates of one V-shaped antenna are symmetrical about a first plane, and the center line extending along the axis of the mounting bracket is located on the first plane.

In one embodiment, the V-shaped antenna includes a first V-shaped antenna, a second V-shaped antenna, and a third V-shaped antenna. A mounting plate of the first V-shaped antenna includes a first mounting plate and a second mounting plate, a first radiating element array is mounted on a surface of the first mounting plate, and a second radiating element array is mounted on a surface of the second mounting plate. A mounting plate of the second V-shaped antenna includes a third mounting plate and a fourth mounting plate, a third radiating element array is mounted on a surface of the third mounting plate, and a fourth radiating element array is mounted on a surface of the fourth mounting plate. A mounting plate of the third V-shaped antenna includes a fifth mounting plate and a sixth mounting plate, a fifth radiating element array is mounted on a surface of the fifth mounting plate, and a sixth radiating element array is mounted on a surface of the sixth mounting plate. The three antennas may cover a range of 360° around the periphery of the mounting bracket by properly arranging the first V-shaped antenna, the second V-shaped antenna, and the third V-shaped antenna. In addition, there may be a plurality of coordinated operating manners by controlling coordination of radiating element arrays of different antennas.

Specifically, when the first V-shaped antenna, the second V-shaped antenna, and the third V-shaped antenna are mounted, the three V-shaped antennas may be evenly arranged on the periphery of the mounting bracket circumferentially. Therefore, signal coverage may be uniform, and a radiation signal generated by an antenna may be fully used.

In one embodiment, the first V-shaped antenna, the second V-shaped antenna, and the third V-shaped antenna coordinately cover three cells. Specifically, a signal radiated by the second radiating element array and a signal radiated by the third radiating element array cover a first cell, a signal radiated by the fourth radiating element array and a signal radiated by the fifth radiating element array cover a second cell, and a signal radiated by the sixth radiating element array and a signal radiated by the first radiating element array cover a third cell. The three antennas in this solution are all V-shaped antennas, and there is little blocking between the antennas, thereby helping improve the gain of the communication system.

When the foregoing operating scenario is specifically implemented, the second mounting plate is adjacent to the third mounting plate, the fourth mounting plate is adjacent to the fifth mounting plate, and the sixth mounting plate is adjacent to the first mounting plate. In other words, adjacent radiating elements operate in coordination to cover a same cell. This helps implement signal coordination, reduces signal blocking, and improves a signal coverage effect and strength in the cell.

To improve a signal coverage effect of each cell, the second mounting plate is parallel to the third mounting plate, so that the second radiating element array and the third radiating element array have a same normal direction. This helps improve signal uniformity in a coverage cell, and helps increase coverage areas of signals of the second radiating element array and the third radiating element array, that is, increase an area of the first cell. Similarly, the fourth mounting plate is parallel to the fifth mounting plate, and the sixth mounting plate is parallel to the first mounting plate. Therefore, signal uniformity in each cell is good, and a signal coverage area is large.

In another embodiment, the V-shaped antenna includes a fourth V-shaped antenna and a fifth V-shaped antenna. A mounting plate of the fourth V-shaped antenna includes a seventh mounting plate and an eighth mounting plate, a seventh radiating element array is mounted on a surface of the seventh mounting plate, and an eighth radiating element array is mounted on a surface of the eighth mounting plate. A mounting plate of the fifth V-shaped antenna includes a ninth mounting plate and a tenth mounting plate, a ninth radiating element array is mounted on a surface of the ninth mounting plate, and a tenth radiating element array is mounted on a surface of the tenth mounting plate. A signal radiated by the seventh radiating element array covers a fourth cell, a signal radiated by the eighth radiating element array and a signal radiated by the ninth radiating element array cover a fifth cell, and a signal radiated by the tenth radiating element array covers a sixth cell. In this embodiment, three cells are covered by using two V-shaped antennas, thereby helping reduce costs of the communication system.

The V-shaped antenna includes a circuit module, the circuit module includes a plurality of signal channels, one radiating element array includes a plurality of radiating elements, and one signal channel is connected to at least one radiating element. Two radiating element arrays whose radiated signals cover a same cell are arranged in a same manner, and connection relationships between radiating elements in the two radiating element arrays and the signal channel are the same. In this solution, SRS channel estimation may be separately performed for the two radiating element arrays, so that hardware resource reusing can be implemented, thereby helping reduce costs of the V-shaped antenna.

In another embodiment, two radiating element arrays whose radiated signals cover a same cell are arranged in an axisymmetrical manner, and connection relationships between radiating elements in the two radiating element arrays and a signal channel are also axisymmetrical. This solution facilitates joint signal estimation of the two radiating element arrays, and makes it easy to design an A2B transformation matrix, thereby improving channel estimation performance of the communication system. The A2B transformation matrix is a transformation matrix from an antenna domain to a beam domain.

Driving relationships of two radiating element arrays corresponding to a same cell may be the same or different. For example, in one embodiment, two radiating element arrays whose radiated signals cover a same cell are arranged differently. In one of the two radiating element arrays, every N radiating elements are connected to one signal channel. In the other one of the two radiating element arrays, in a part of a plurality of radiating elements, every M radiating elements are connected to one signal channel, and in a part of the plurality of radiating elements, every L radiating elements are connected to one signal channel, where ML.

In one embodiment, in one of two radiating element arrays whose radiated signals cover a same cell, every O radiating elements are connected to one signal channel; and in the other of the two radiating element arrays, in a part of a plurality of radiating elements, every P radiating elements are connected to one signal channel, where O≠P. In this case, driving relationships of the two radiating element arrays 12 are different, thereby improving flexibility of signal channel arrangement. Alternatively, in another embodiment, if O=P, driving relationships of the two radiating element arrays are the same, and same beam weights may be designed for the two radiating element arrays.

To improve flexibility of an antenna, the V-shaped antenna includes a driving mechanism, and the driving mechanism is separately connected to the two mounting plates. The driving mechanism is configured to drive the mounting plate to rotate about a mechanical downtilt rotation axis, so that a normal direction of a radiating element array on the mounting plate can be adjusted, and a coverage region of the radiating element array can be adjusted. Specifically, a mechanical downtilt rotation axis of each mounting plate is parallel to a corresponding mounting plate, so that a rotation direction and angle of the mounting plate are easily controlled.

In an embodiment, the driving mechanism includes a first driving mechanism and a second driving mechanism. The first driving mechanism is connected to one mounting plate of the V-shaped antenna, and is configured to drive the one mounting plate to rotate about a mechanical downtilt rotation axis of the mounting plate. The other driving mechanism is connected to the other mounting plate of the V-shaped antenna, and is configured to drive the other mounting plate to rotate about a mechanical downtilt rotation axis of the other mounting plate. Mechanical downtilt of two mounting plates of one V-shaped antenna is decoupled. When the mechanical downtilt of one mounting plate is adjusted, mechanical downtilt may be performed on the other mounting plate, or the other mounting plate may remain stationary, or mechanical downtilt angles or directions of the two mounting plates are different.

Specifically, the mechanical downtilt rotation axis is perpendicular to the center line extending along the axis of the mounting bracket. When the mounting plate rotates about the mechanical downtilt rotation axis, it can be ensured that there is a specific position relationship between the mounting plate and the mounting bracket, and the mounting plate does not deflect along a direction of the mechanical downtilt rotation axis.

In an embodiment, the mounting plate is a square mounting plate, and the mechanical downtilt rotation axis is parallel to at least one side edge of the square mounting plate. For example, the mechanical downtilt rotation axis is parallel to a top edge or a bottom edge of the square mounting plate.

In an actual application process, even if an angle of the mounting plate is adjusted by using the driving mechanism, mounting plates on which two radiating element arrays whose radiated signals cover a same cell are located remain parallel. In this way, signals in a cell can be kept to have specific uniformity, and a large coverage area is large.

The V-shaped antenna further includes a circuit module. The circuit module is connected to the radiating element array, and the circuit module is mounted on sides that are of the two mounting plates and that are away from the radiating element arrays. The circuit module and the mounting plate are integrated into an integrated structure. This can implement modularization of the V-shaped antenna.

According to a second aspect, this application further provides a V-shaped antenna, where the V-shaped antenna is mounted on a mounting bracket. The V-shaped antenna includes two mounting plates. A radiating element array is mounted on a surface of a side that is of each mounting plate and that is away from the mounting bracket, and planes on which the two mounting plates are located intersect, to form a V-shaped structure. A first included angle exists between the first mounting plate and the second mounting plate. Specifically, one of the two mounting plates has a first axis, the other mounting plate has a second axis, and the first axis and the second axis are perpendicular to a center line extending along an axis of the mounting bracket. A first included angle β exists between the first axis and the second axis, and the first included angle β is less than or equal to 150°. The V-shaped antenna occupies a small area of a frontal area, and a large quantity of radiating elements may be arranged, thereby maximally optimizing a relationship between the frontal area and a radiation area. In addition, adjacent V-shaped antenna brackets are less prone to signal blocking, thereby helping improve a gain of a communication system.

In one embodiment, an angle of the first included angle β may be 60° or 120°. In this way, blocking between adjacent antennas may be maximally reduced, thereby helping improve the gain of the communication system, and helping implement coordination between different V-shaped antennas in the communication system, to serve different cells.

Specifically, areas of the two mounting plates of one V-shaped antenna are the same, thereby helping simplify a design of the V-shaped antenna and control of a radiation signal.

In a state in which the V-shaped antenna is mounted on the mounting bracket, two mounting plates of one V-shaped antenna are symmetrical about a first plane, and the center line extending along the axis of the mounting bracket is located on the first plane.

To improve flexibility of an antenna, the V-shaped antenna includes a driving mechanism, and the driving mechanism is separately connected to the two mounting plates. The driving mechanism is configured to drive the mounting plate to rotate about a mechanical downtilt rotation axis, so that a normal direction of a radiating element array on the mounting plate can be adjusted, and a coverage region of the radiating element array can be adjusted. Specifically, a mechanical downtilt rotation axis of each mounting plate is parallel to a corresponding mounting plate, so that a rotation direction and angle of the mounting plate are easily controlled.

In an embodiment, the driving mechanism includes a first driving mechanism and a second driving mechanism. The first driving mechanism is connected to one mounting plate of the V-shaped antenna, and is configured to drive the one mounting plate to rotate about a mechanical downtilt rotation axis of the mounting plate. The other driving mechanism is connected to the other mounting plate of the V-shaped antenna, and is configured to drive the other mounting plate to rotate about a mechanical downtilt rotation axis of the other mounting plate. Mechanical downtilt of two mounting plates of one V-shaped antenna is decoupled. When the mechanical downtilt of one mounting plate is adjusted, mechanical downtilt may be performed on the other mounting plate, or the other mounting plate may remain stationary, or mechanical downtilt angles or directions of the two mounting plates are different.

Specifically, the mechanical downtilt rotation axis is perpendicular to the center line extending along the axis of the mounting bracket. When the mounting plate rotates about the mechanical downtilt rotation axis, it can be ensured that there is a specific position relationship between the mounting plate and the mounting bracket, and the mounting plate does not deflect along a direction of the mechanical downtilt rotation axis.

In an embodiment, the mounting plate is a square mounting plate, and the mechanical downtilt rotation axis is parallel to at least one side edge of the square mounting plate. For example, the mechanical downtilt rotation axis is parallel to a top edge or a bottom edge of the square mounting plate.

The V-shaped antenna further includes a circuit module. The circuit module is connected to the radiating element array, and the circuit module is mounted on sides that are of the two mounting plates and that are away from the radiating element arrays. The circuit module and the mounting plate are integrated into an integrated structure. This can implement modularization of the V-shaped antenna.

### BRIEF DESCRIPTION OF DRAWINGS

FIG. 1 is a diagram of an architecture of a communication system to which an embodiment of this application is applicable;

FIG. 2 is a diagram of a structure of a communication system according to a possible embodiment of this application;

FIG. 3 is a diagram of composition of an antenna according to a possible embodiment of this application;

FIG. 4 is a diagram of a structure of a communication system in a conventional technology;

FIG. 5 is a diagram of a structure of a communication system in a conventional technology;

FIG. 6 is a diagram of a structure of a communication system according to an embodiment of this application;

FIG. 7 is a diagram of a structure of a communication system according to an embodiment of this application;

FIG. 8 is a diagram of a structure of a communication system according to an embodiment of this application;

FIG. 9 is a diagram of a structure of a V-shaped antenna according to an embodiment of this application;

FIG. 10 is a diagram of a structure of a communication system according to an embodiment of this application;

FIG. 11 is a diagram of a structure of a communication system according to an embodiment of this application;

FIG. 12 is a diagram of a structure of a V-shaped antenna according to an embodiment of this application;

FIG. 13 is a diagram of a structure of a V-shaped antenna according to an embodiment of this application;

FIG. 14 is a diagram of a structure of a V-shaped antenna according to an embodiment of this application;

FIG. 15 is a diagram of a structure of a V-shaped antenna according to an embodiment of this application;

FIG. 16 is a diagram of a structure of a V-shaped antenna according to an embodiment of this application;

FIG. 17 is a diagram of a structure of a V-shaped antenna according to an embodiment of this application;

FIG. 18 is a diagram of a structure of a V-shaped antenna according to an embodiment of this application;

FIG. 19 is a diagram of radiating element arrays according to an embodiment of this application;

FIG. 20 is a diagram of radiating element arrays according to an embodiment of this application;

FIG. 21 is a diagram of radiating element arrays according to an embodiment of this application; and

FIG. 22 is a diagram of mechanical downtilt of a V-shaped antenna according to an embodiment of this application.

Reference numerals:

| | |
|---|---|
| 100: antenna; | 110: radome; |
| 120: radiating element; | 130: reflection panel; |
| 140: feeding network; | 200: mounting bracket; |
| 300: antenna mounting kit; | 400: radio frequency processing unit; |
| 500: baseband processing unit; | 600: cable; |
| 1: V-shaped antenna; | 11: mounting plate; |
| 12: radiating element array; | 13: first V-shaped antenna; |
| 131: first mounting plate; | 132: second mounting plate; |
| 14: second V-shaped antenna; | 141: third mounting plate; |
| 142: fourth mounting plate; | 15: third V-shaped antenna; |
| 151: fifth mounting plate; | 152: sixth mounting plate; |
| 16: fourth V-shaped antenna; | 161: seventh mounting plate; |
| 162: eighth mounting plate; | 17: fifth V-shaped antenna; |
| 171: ninth mounting plate; | 172: tenth mounting plate; |
| 18: circuit module; | 19: driving mechanism; |
| 191: mechanical downtilt | |
| rotation axis. | |

### DESCRIPTION OF EMBODIMENTS

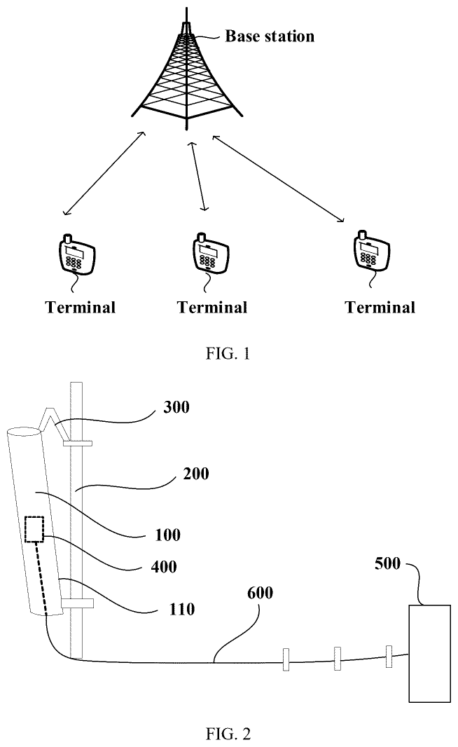

To facilitate understanding of a V-shaped antenna and a communication system provided in embodiments of this application, the following describes application scenarios of the V-shaped antenna and the communication system. FIG. 1 is an example diagram of an architecture of a communication system to which an embodiment of this application is applicable. As shown in FIG. 1, the communication system may be a base station antenna feeder system. The application scenario may include a base station and a terminal. Wireless communication may be implemented between the base station and the terminal. The base station may be located in a base station subsystem (BBS), a UMTS terrestrial radio access network (UTRAN), or an evolved universal terrestrial radio access network (evolved universal terrestrial radio access network, E-UTRAN), and is configured to perform radio signal cell coverage to implement communication between a terminal device and a wireless network. Specifically, the base station may be a base transceiver station (BTS) in a global system for mobile communications (GSM) or a code division multiple access (CDMA) system, or may be a NodeB (NB) in a wideband code division multiple access (WCDMA) system, or may be an evolved NodeB eNB or eNodeB) in a long term evolution (LTE) system, or may be a radio controller in a cloud radio access network (CRAN) scenario. Alternatively, the base station may be a relay station, an access point, a vehicle-mounted device, a wearable device, a gNodeB (gNB) in a new radio (NR) system, a base station in a future evolved network, or the like. This is not limited in embodiments of this application.

In addition, the base station may be a macro base station or a micro base station. The communication system may implement coordinated multipoint transmission between macro base stations, between micro base stations, or between a macro base station and a micro base station. In addition, the communication system in this application is applicable to a low frequency scenario (sub 6G) and a high frequency scenario (above 6G); is applicable to 4G, 5G, or a future mobile communication system; is applicable to a single-transmission reception point (Single-TRP) scenario, a multi-transmission reception point (Multi-TRP) scenario, and any derivative scenario thereof; is applicable to a new radio access technology (NR) uplink transmission scenario; and is applicable to homogeneous network and heterogeneous network scenarios.

FIG. 2 is a diagram of a possible structure of a communication system. A base station antenna feeder system may generally include structures such as an antenna 100, a mounting bracket 200, and an antenna mounting kit 300. The antenna 100 of a base station may include a radome 110. The radome 110 has a good electromagnetic wave penetration characteristic in terms of electrical performance, and can withstand impact of a harsh external environment in terms of mechanical performance, thereby protecting the antenna 100 from the impact of the external environment. The antenna 100 may be mounted on the mounting bracket 200 through the antenna mounting kit 300, to facilitate signal receiving or transmitting by the antenna 100. Certainly, the embodiment shown in FIG. 2 is merely used as an example. During specific implementation, the antenna and the base station antenna feeder system in embodiments of this application may be shown in the embodiment in FIG. 2.

In addition, the base station may further include a radio frequency processing unit 400 and a baseband processing unit 500. For example, the radio frequency processing unit 400 may be configured to: perform frequency selection, amplification, and down-conversion processing on a signal received by the antenna 100, convert the signal into an intermediate frequency signal or a baseband signal, and send the intermediate frequency signal or the baseband signal to the baseband processing unit 500. Alternatively, the radio frequency processing unit 400 is configured to: perform up-conversion and amplification processing on a baseband signal or an intermediate frequency signal, convert the signal into an electromagnetic wave through the antenna 100, and send the electromagnetic wave. The baseband processing unit 500 may be connected to a feeding network of the antenna 100 through the radio frequency processing unit 400. In some implementations, the radio frequency processing unit 400 may also be referred to as a remote radio unit (RRU), and may be a radio frequency module in an active antenna unit (AAU). The baseband processing unit 500 may also be referred to as a baseband unit (BBU).

In a possible embodiment, as shown in FIG. 2, the radio frequency processing unit 400 and the antenna 100 may be integrally disposed, and the baseband processing unit 500 is located at a remote end of the antenna 100. In some other embodiments, both the radio frequency processing unit 400 and the baseband processing unit 500 may be located at a remote end of the antenna 100. The radio frequency processing unit 400 and the baseband processing unit 500 may be connected through a cable 600.

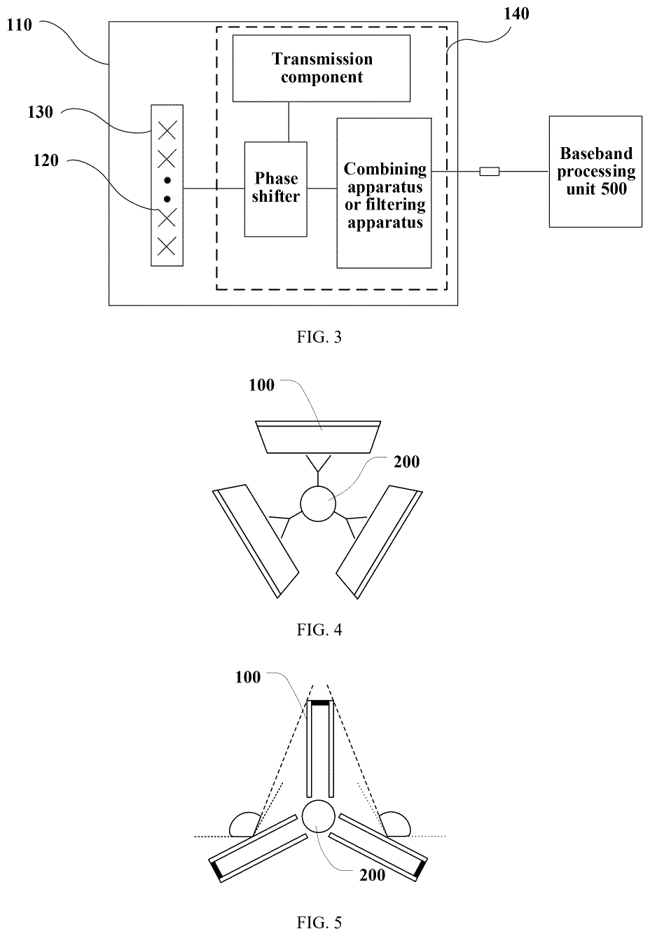

More specifically, refer to both FIG. 2 and FIG. 3. FIG. 3 is a diagram of composition of an antenna according to a possible embodiment of this application. As shown in FIG. 3, the antenna 100 of the base station may include a radiating element 120 and a reflection panel 130. The radiating element 120 may also be referred to as an antenna element, an element, or the like, and can effectively send or receive an antenna signal. In the antenna 100, frequencies of different radiating elements 120 may be the same or different. The reflection panel 130 may also be referred to as a bottom panel, an antenna panel, a reflective surface, or the like, and may be made of metal. When the antenna 100 receives a signal, the reflection panel 130 may reflect the antenna signal to a target coverage region. When the antenna 100 transmits a signal, the reflection panel 130 may reflect and transmit the signal incident on the reflection panel 130. The radiating element 120 is usually placed on a surface of a side of the reflection panel 130. This can not only greatly enhance a capability of the antenna 100 to receive or transmit a signal, but also block and shield interference to reception of an antenna signal from other electric waves from a back side of the reflection panel 130 (the back side of the reflection panel 130 in this application is a side opposite to a side of the reflection panel 130 on which the radiating element 120 is disposed).

In the antenna 100 of the base station, the radiating element 120 is connected to the feeding network 140. The feeding network 140 is generally formed by controlled impedance transmission lines. The feeding network 140 may feed a signal to the radiating element 120 based on a specific amplitude and phase, or send a received signal to the baseband processing unit 500 of the base station based on a specific amplitude and phase. Specifically, in some implementations, the feeding network 140 may be configured to implement different radiation beam directions, or may be connected to a calibration network to obtain a calibration signal needed by the system. The feeding network 140 may include a phase shifter, to change a phase of antenna signal radiation. Some modules used for performance expansion may be further disposed in the feeding network 140, for example, a combiner, which may be configured to combine signals of different frequencies into one signal and transmit the signal through the antenna 100; or when used in reverse, may be configured to divide, based on different frequencies, a signal received by the antenna 100 into a plurality of signals and transmit the signals to the baseband processing unit 500 for processing; or for another example, a filter, which is configured to filter out an interference signal.

It should be noted that embodiments that are related to the term “specific” such as “specific”, “specifically disposed”, and “specifically designed” in this application are all example embodiments. In other words, this embodiment is a possible specific embodiment under the inventive concept of this application, but another possible embodiment is further included.

FIG. 4 is a diagram of a structure of a communication system in a conventional technology. In the solution shown in FIG. 4, the communication system includes an antenna 100 mounted on a periphery of a mounting bracket 200. Each antenna 100 is a planar antenna, and includes a planar mounting plate. A radiating element is mounted on the planar mounting plate. A small quantity of radiating elements are disposed on a specific frontal area, and a system capacity gain is small. FIG. 5 is a diagram of a structure of a communication system in a conventional technology. As shown in FIG. 5, to increase a capacity gain of the communication system, an antenna 100 in the communication system may alternatively be a flag antenna. The flag antenna includes two parallel mounting plates. This can reduce an area of a frontal area and increase a quantity of radiating elements in the system. However, signal blocking occurs between adjacent antennas, and consequently a gain of an actual communication system is limited. In addition, in this solution, interference is likely to occur between cells with different signal coverage.

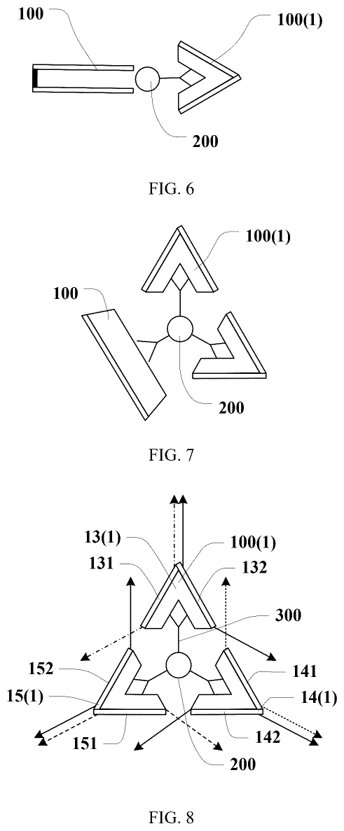

FIG. 6 is a diagram of a structure of a communication system according to an embodiment of this application. As shown in FIG. 6, in an embodiment, the communication system provided in this application includes a mounting bracket 200 and at least two antennas 100. The at least two antennas 100 are mounted on the mounting bracket 200 around a periphery of the mounting bracket 200. The at least two antennas 100 include a V-shaped antenna 1. In an embodiment, a specific quantity of antennas 100 included in the communication system and a quantity of V-shaped antennas 1 included in the communication system are not limited. The following lists a plurality of possible embodiments for reference. For example, as shown in FIG. 6, in an embodiment, the communication system includes two antennas 100. One of the two antennas 100 is a V-shaped antenna 1, and the other antenna 100 may be a flag antenna. FIG. 7 is a diagram of a structure of a communication system according to an embodiment of this application. As shown in FIG. 7, in an embodiment, the communication system includes three antennas 100, including two V-shaped antennas 1 and one planar antenna. FIG. 8 is a diagram of a structure of a communication system according to an embodiment of this application. As shown in FIG. 8, in an embodiment, the communication system includes three antennas 100, all of which are V-shaped antennas 1.

Specifically, when the V-shaped antenna 1 is mounted on the mounting bracket 200, an antenna mounting kit 300 may be used to connect the V-shaped antenna 1 and the mounting bracket 200. In an embodiment, the antenna mounting kit 300 is of a Y-shaped structure. Specifically, one end of the antenna mounting kit 300 includes two branches, which are respectively connected to two mounting plates 11 in one-to-one correspondence, and the other end is connected to the mounting bracket 200, so that the V-shaped antenna 1 is stably and reliably mounted on the mounting bracket 200.

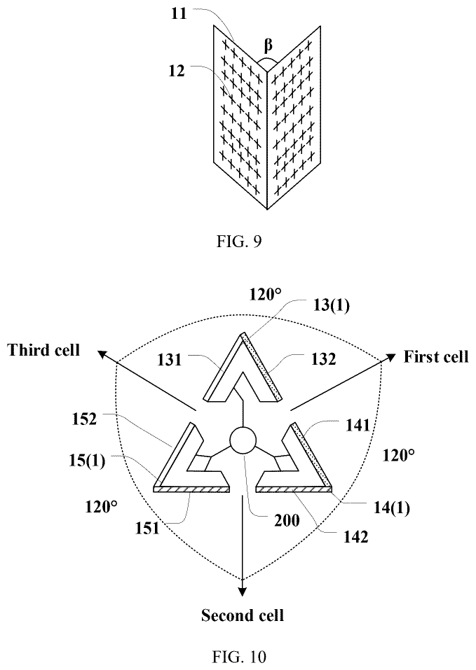

FIG. 9 is a diagram of a structure of a V-shaped antenna according to an embodiment of this application. As shown in FIG. 9, in an embodiment, the V-shaped antenna 1 provided in this application includes two mounting plates 11, and a radiating element array 12 is mounted on a surface of a side that is of each mounting plate 11 and that is away from the mounting bracket 200, to form two antenna panels. One radiating element array 12 includes a plurality of radiating elements. Planes on which the two mounting plates 11 are located intersect, and an included angle between the two mounting plates 11 is a first included angle β. The first included angle β is less than or equal to 150°, that is, β≤150°. Specifically, the V-shaped antenna 1 includes a total of two mounting plates 11 for disposing the radiating element array 12, and the two mounting plates 11 are formed into a V-shaped structure, or roughly in a V-shaped structure. The radiating element array 12 is disposed on an outer surface of the V-shaped structure. The first included angle β may be determined in a plurality of manners. In a determining manner, an included angle between the planes on which the two mounting plates 11 are located may be used as the first included angle β. Alternatively, in a determining manner, one of the two mounting plates 11 has a first axis, the other mounting plate 11 has a second axis, the first axis and the second axis are perpendicular to a center line extending along an axis of the mounting bracket 200, and an included angle between the first axis and the second axis is the first included angle β. Alternatively, in a determining manner, both the two mounting plates 11 are rectangular mounting plates 11, and at least one group of edges of the two mounting plates 11 are parallel. For example, a long edge of one of the two mounting plates 11 is parallel to a long edge of the other mounting plate 11, and is parallel to the center line extending along the axis of the mounting bracket 200. An included angle between a short edge of one of the two mounting plates 11 and a short edge of the other of the two mounting plates 11 is the first included angle β. When both the mounting plates 11 are square mounting plates, a distinction between a long edge and a short edge is not made, and it may be considered that two perpendicular edges of the square mounting plate are respectively equivalent to a long edge and a short edge. When the mounting plate 11 is a rectangular mounting plate, the first axis may be parallel to one edge of a corresponding mounting plate 11, and the second axis may be parallel to one edge of a corresponding mounting plate 11.

This embodiment of this application provides a V-shaped antenna 1. The V-shaped antenna 1 occupies a small area of a frontal area, and may accommodate a large quantity of radiating elements, thereby maximally optimizing a relationship between the frontal area and a radiation area. Refer to FIG. 8. Adjacent V-shaped antenna 1 brackets are less prone to signal blocking, thereby helping improve a gain of a communication system.

In an embodiment, the mounting plate 11 includes a reflection panel 130. That is, in addition to mounting the radiating element 120, the mounting plate 11 may be further used as the reflection panel 130 to reflect a signal of the radiating element. For example, the mounting plate 11 may be a structure made of a metal material or the like, to serve as the reflection panel 130; or the reflection panel 130 may be prepared by coating a surface of the mounting plate 11 with a reflective material layer.

In a specific embodiment, an angle of the first included angle β is 60° or 120°. In the embodiment shown in FIG. 8, in a typical application scenario, the communication system includes three V-shaped antennas 1 evenly arranged on a periphery of the mounting bracket 200. In this way, blocking between adjacent antennas 100 may be maximally reduced, thereby helping improve a gain of the communication system, and helping implement coordination between different V-shaped antennas 1 in the communication system, to serve different cells.

In an embodiment, shapes and areas of two mounting plates 11 of one V-shaped antenna 1 may be the same or different. In a specific embodiment, shapes and areas of two mounting plates 11 of one V-shaped antenna 1 are the same. This makes a structure of the V-shaped antenna 1 be regular, and facilitates arrangement of the antenna radiating element array 12, thereby helping simplify control of the antenna 100.

When the V-shaped antenna 1 is mounted on the mounting bracket 200, there may be a plurality of options for a position relationship between the V-shaped antenna 1 and the mounting bracket 200, and the V-shaped antenna 1 may be arranged based on a signal coverage requirement. As shown in FIG. 8, in an application scenario, two mounting plates 11 of one V-shaped antenna 1 are symmetrical about a first plane, and the center line extending along the axis of the mounting bracket 200 is located on the first plane. The two mounting plates 11 of the one V-shaped antenna 1 are also symmetrical about the center line extending along the axis of the mounting bracket 200.

In an embodiment, a plurality of V-shaped antennas 1 in the communication system are evenly arranged around a periphery of the mounting bracket 200, thereby helping improve uniformity of signals of the plurality of V-shaped antennas 1 in a coverage region.

For ease of description, it is considered that the three V-shaped antennas 1 included in the communication system shown in FIG. 8 are respectively a first V-shaped antenna 13, a second V-shaped antenna 14, and a third V-shaped antenna 15. A mounting plate 11 of the first V-shaped antenna 13 includes a first mounting plate 131 and a second mounting plate 132, a first radiating element array is mounted on a surface of the first mounting plate 131, and a second radiating element array is mounted on a surface of the second mounting plate 132. A mounting plate 11 of the second V-shaped antenna 14 includes a third mounting plate 141 and a fourth mounting plate 142, a third radiating element array is mounted on a surface of the third mounting plate 141, and a fourth radiating element array is mounted on a surface of the fourth mounting plate 142. A mounting plate 11 of the third V-shaped antenna 15 includes a fifth mounting plate 151 and a sixth mounting plate 152, a fifth radiating element array is mounted on a surface of the fifth mounting plate 151, and a sixth radiating element array is mounted on a surface of the sixth mounting plate 152.

FIG. 10 is a diagram of a structure of a communication system according to an embodiment of this application. As shown in FIG. 10, in an actual operating process, the antenna 100 may have a plurality of networking forms. In a typical networking form, a signal radiated by the second radiating element array on the second mounting plate 132 and a signal radiated by the third radiating element array on the third mounting plate 141 cover a first cell, that is, the second radiating element array and the third radiating element array correspond to one cell; a signal radiated by the fourth radiating element array on the fourth mounting plate 142 and a signal radiated by the fifth radiating element array on the fifth mounting plate 151 cover a second cell, that is, the fourth radiating element array and the fifth radiating element array correspond to one cell; and a signal radiated by the sixth radiating element array on the sixth mounting plate 152 and a signal radiated by the first radiating element array on the first mounting plate 131 cover a third cell, and the sixth radiating element array and the first radiating element array correspond to one cell. To implement the foregoing functions, the second radiating element array and the third radiating element array operate in coordination, the fourth radiating element array and the fifth radiating element array operate in coordination, and the sixth radiating element array and the first radiating element array operate in coordination.

Specifically, when the three V-shaped antennas 1 in the communication system are disposed, the second mounting plate 132 is adjacent to the third mounting plate 141, the fourth mounting plate 142 is adjacent to the fifth mounting plate 151, and the sixth mounting plate 152 is adjacent to the first mounting plate 131. Therefore, two radiating element arrays 12 corresponding to a same cell are adjacent. This helps the two radiating element arrays operate in coordination, and helps reduce signal blocking and improve a signal coverage effect and strength in a cell.

In addition, the second mounting plate 132 is parallel to the third mounting plate 141, so that the second radiating element array and the third radiating element array have a same normal direction. This helps improve signal uniformity in a coverage cell, and helps increase coverage areas of signals of the second radiating element array and the third radiating element array, that is, increase an area of the first cell. Similarly, the fourth mounting plate 142 is parallel to the fifth mounting plate 151, so that the fourth radiating element array and the fifth radiating element array have a same normal direction. This helps improve signal uniformity in a coverage cell, and helps increase coverage areas of signals of the fourth radiating element array and the fifth radiating element array, that is, increase an area of the second cell. The sixth mounting plate 152 is parallel to the first mounting plate 131, so that the sixth radiating element array and the first radiating element array have a same normal direction. This helps improve signal uniformity in a coverage cell, and helps increase coverage areas of signals of the sixth radiating element array and the first radiating element array, that is, increase an area of the third cell.

In an embodiment, a first included angle β is 60° for all of the three V-shaped antennas 1, and the three V-shaped antennas 1 are evenly arranged on a periphery of a mounting bracket 200. The communication system serves three cells, so that the three cells are equally divided circumferentially, and each cell covers a range of 120°. In another embodiment, the three cells may not be evenly arranged on a periphery of the mounting bracket 200, or at least one V-shaped antenna 1 is not symmetrically disposed relative to the mounting bracket 200, so that signal strength of some of the cells can be enhanced in a targeted manner.

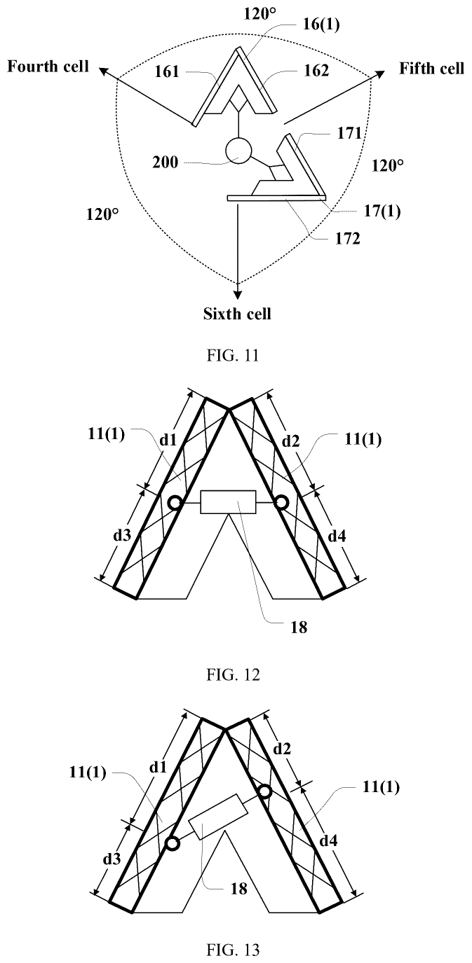

FIG. 11 is a diagram of a structure of a communication system according to an embodiment of this application. As shown in FIG. 11, in another embodiment, a V-shaped antenna 1 included in the communication system includes a fourth V-shaped antenna 16 and a fifth V-shaped antenna 17. A mounting plate 11 of the fourth V-shaped antenna 16 includes a seventh mounting plate 161 and an eighth mounting plate 162, a seventh radiating element array is mounted on a surface of the seventh mounting plate 161, and an eighth radiating element array is mounted on a surface of the eighth mounting plate 162. A mounting plate 11 of the fifth V-shaped antenna 17 includes a ninth mounting plate 171 and a tenth mounting plate 172, a ninth radiating element array is mounted on a surface of the ninth mounting plate 171, and a tenth radiating element array is mounted on a surface of the tenth mounting plate 172. During specific operating, a signal radiated by the seventh radiating element array on the seventh mounting plate 161 covers a fourth cell, a signal radiated by the eighth radiating element array on the eighth mounting plate 162 and a signal radiated by the ninth radiating element array on the ninth mounting plate 171 cover a fifth cell, and a signal radiated by the tenth radiating element array on the tenth mounting plate 172 covers a sixth cell. In this embodiment, two V-shaped antennas 1 are used to cover three cells.

It should be noted that, in addition to the fourth V-shaped antenna 16 and the fifth V-shaped antenna 17, the communication system may further include another antenna, or may not include another antenna. For example, the communication system may include only the fourth V-shaped antenna 16 and the fifth V-shaped antenna 17. Alternatively, in addition to the fourth V-shaped antenna 16 and the fifth V-shaped antenna 17, the communication system may further include one antenna 100, two antennas 100, or more antennas 100. In addition, the antenna 100 in the communication system other than the fourth V-shaped antenna 16 and the fifth V-shaped antenna 17 may include a V-shaped antenna 1, a flag antenna, or a planar antenna.

To implement an operating process of the V-shaped antenna 1, the V-shaped antenna 1 in this embodiment of this application further includes a circuit module 18, which may also be referred to as a radio frequency board. The circuit module 18 is connected to a radiating element of a radiating element array 12, so that signals transmitted or received through the radiating element can be processed and transmitted through the circuit module 18. In an embodiment, the circuit module 18 and the mounting plate 11 may be fixed to each other, so that the V-shaped antenna 1 can be formed into a module having a specific function, and modularization of the V-shaped antenna 1 can be implemented, thereby simplifying a process of mounting the V-shaped antenna 1 in the communication system.

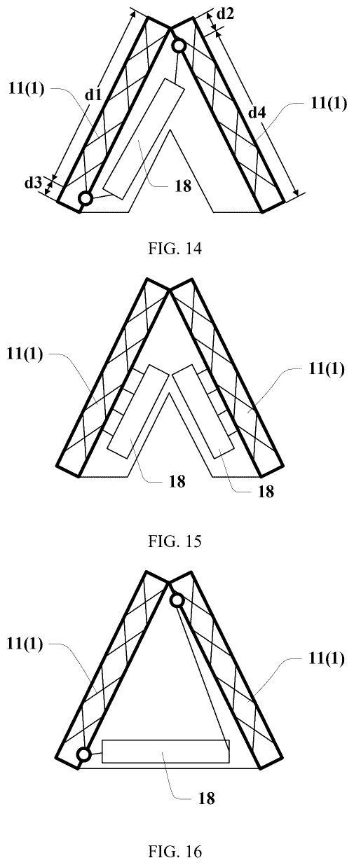

FIG. 12 to FIG. 15 are diagrams of a plurality of structures of a V-shaped antenna according to an embodiment of this application. As shown in FIG. 12 to FIG. 15, a V-shaped bracket is disposed on a side that is of the V-shaped antenna and that is away from a radiating element array, a V-shaped accommodating cavity is formed between the V-shaped bracket and a mounting plate, and the circuit module 18 is disposed in the V-shaped accommodating cavity. Specifically, in the V-shaped antenna 1, there are a plurality of options for setting a position of the circuit module 18. For example, when the foregoing circuit module 18 is specifically mounted, the circuit module 18 may be mounted on sides that are of two mounting plates 11 and that are away from radiating element arrays 12, to reduce impact of the circuit module 18 on a signal of the radiating element. In addition, there is specific accommodating space on the sides that are of two mounting plates 11 of a V-shaped antenna 1 and that are away from the radiating element arrays 12, which is used to mount the circuit module 18. As shown in FIG. 12 to FIG. 14, in an embodiment, the V-shaped antenna 1 may include one circuit module 18. The circuit module 18 is separately connected to the two mounting plates 11, and may be connected to different positions of the two mounting plates 11. For example, two mounting plates 11 of one V-shaped antenna 1 have a same width. As shown in FIG. 12, in an embodiment, two ends of the circuit module 18 are respectively connected to the two mounting plates 11, and connection points of the circuit module 18 and the mounting plates 11 are symmetrically disposed, for example, d1=d2 and d3=d4 in FIG. 12. As shown in FIG. 13, in an embodiment, two ends of the circuit module 18 are respectively connected to the two mounting plates 11, and the two ends of the circuit module 18 are respectively in a central symmetry relationship with connection points of the two mounting plates 11, for example, d1=d4 and d2=d3 in FIG. 13. As shown in FIG. 14, in an embodiment, two ends of the circuit module 18 are respectively connected to one end and one tail of the two mounting plates 11. As shown in FIG. 14, one end of the circuit module 18 is connected to one end that is of one mounting plate 11 and that is away from the other mounting plate 11, and the other end is connected to one end that is of the other mounting plate 11 and that faces the one mounting plate 11. Alternatively, as shown in FIG. 15, in an embodiment, the V-shaped antenna 1 may further include two circuit modules 18. One of the two circuit modules 18 is connected to one of the two mounting plates 11 of the V-shaped antenna 1, and the other circuit module 18 is connected to the other mounting plate 11.

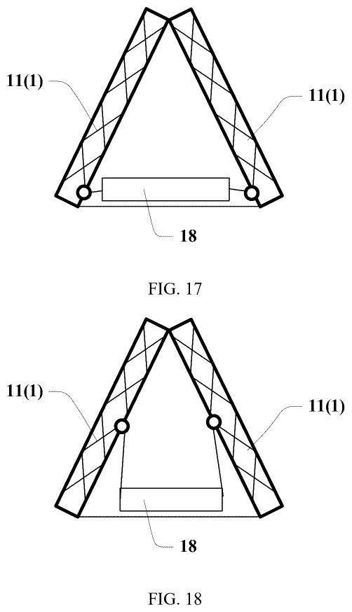

FIG. 16 to FIG. 18 are diagrams of a plurality of structures of a V-shaped antenna according to an embodiment of this application. As shown in FIG. 16 to FIG. 18, a flat-plate bracket is disposed on a side that is of the V-shaped antenna and that is away from a radiating element array, a triangular accommodating cavity is formed between the flat-plate bracket and a mounting plate, and a circuit module 18 is disposed in the triangular accommodating cavity. Specifically, the circuit module 18 is fixed to the flat-plate bracket. This helps improve a heat dissipation effect of the circuit module. Specifically, there are a plurality of options for connection positions between the circuit module 18 and radiating element arrays of the two mounting plates. For example, as shown in FIG. 16, two ends of the circuit module 18 are respectively connected to one end and one tail of the two mounting plates 11; or as shown in FIG. 17, two ends of the circuit module 18 are respectively connected to tails of the two mounting plates 11; or as shown in FIG. 18, two ends of the circuit module 18 are respectively connected to middle parts of the two mounting plates 11.

In a specific embodiment, one circuit module 18 includes a plurality of signal channels, one radiating element array 12 includes a plurality of radiating elements, and one signal channel is connected to at least one radiating element. In this case, one signal channel may be connected to one radiating element, or may be connected to two or more radiating elements.

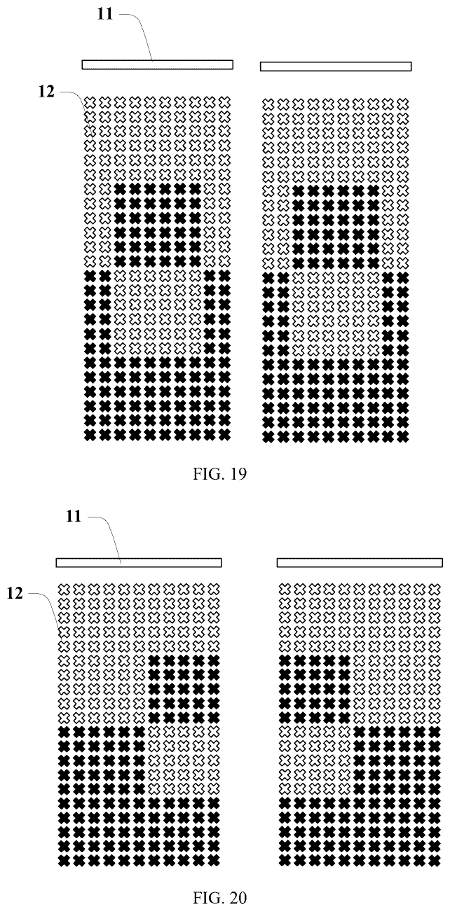

FIG. 19 is a diagram of radiating element arrays according to an embodiment of this application. As shown in FIG. 19, in an embodiment, two radiating element arrays 12 whose radiated signals cover a same cell are arranged in a same manner, and connection relationships between radiating elements in the two radiating element arrays 12 and a signal channel are the same. It may be understood that two radiating element arrays 12 corresponding to a same cell are equivalent to a translation relationship, the radiating elements have a same arrangement, and connection relationships between the radiating elements and the signal channel are also the same. In this solution, SRS channel estimation may be separately performed for the two radiating element arrays 12, so that hardware resource reusing can be implemented, thereby helping reduce costs of a V-shaped antenna 1.

Specifically, as shown in FIG. 19, each radiating element array 12 in the figure is a matrix of 10 columns and 24 rows, forming a triangular matrix of 128T DBF. Cross symbols of same colors that are adjacent in a vertical direction indicates that radiating elements are connected by one channel. For ease of description, a connection relationship in which one channel corresponds to a plurality of elements is referred to as a driving relationship. If one channel is connected to 10 elements, the connection relationship is referred to as a 1-to-10 driving relationship. In the figure, a radiating element array 12 on a mounting plate 11 includes two driving relationships: a 1-to-6 driving relationship and a 1-to-12 driving relationship. Specifically, each of first two columns and last two columns on a panel has two channels, and each of six columns in the middle includes four channels.

FIG. 20 is a diagram of radiating element arrays according to an embodiment of this application. As shown in FIG. 20, in another embodiment, two radiating element arrays 12 whose radiated signals cover a same cell are arranged in an axisymmetrical manner, and connection relationships between radiating elements in the two radiating element arrays 12 and a signal channel are also axisymmetrical. It may be understood that two radiating element arrays 12 corresponding to a same cell are equivalent to a mirror relationship. This solution facilitates joint signal estimation of the two radiating element arrays 12, and makes it easy to design an A2B transformation matrix, thereby improving channel estimation performance of a communication system. The A2B transformation matrix is a transformation matrix from an antenna domain to a beam domain.

Specifically, as shown in FIG. 20, each radiating element array 12 in the figure is a matrix of 11 columns and 24 rows, forming a triangular matrix of 128T DBF. Cross symbols of same colors that are adjacent in a vertical direction indicates that radiating elements are connected by one channel. In the figure, a radiating element array 12 on a mounting plate 11 includes two driving relationships: a 1-to-6 driving relationship and a 1-to-12 driving relationship.

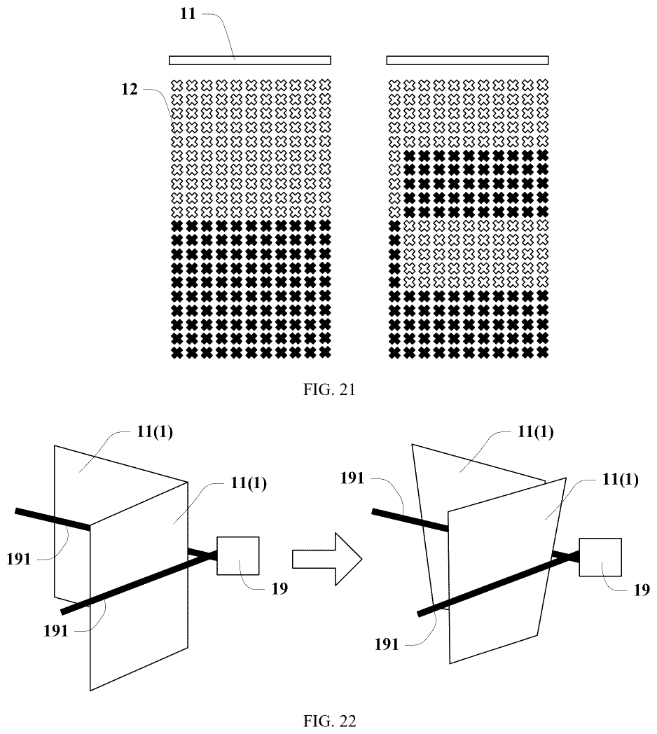

FIG. 21 is a diagram of radiating element arrays according to an embodiment of this application. As shown in FIG. 21, in a specific embodiment, two radiating element arrays 12 whose radiated signals cover a same cell are arranged differently. In one of the two radiating element arrays 12, every N radiating elements are connected to one signal channel, that is, there is a 1-to-N driving relationship. In the other of the two radiating element arrays 12, in a part of a plurality of radiating elements, every M radiating elements are connected to one signal channel, and in a part of the plurality of radiating elements, every L radiating elements are connected to one signal channel, where M≠L. In other words, there are two driving relationships: a 1-to-M driving relationship and a 1-to-L driving relationship. In this case, driving relationships of two radiating element arrays 12 corresponding to a same cell may be different.

Specifically, as shown in FIG. 21, each radiating element array 12 in the figure is a matrix of 11 columns and 24 rows, forming a triangular matrix of 128T DBF. Cross symbols of same colors that are adjacent in a vertical direction indicates that radiating elements are connected by one channel. In the figure, a radiating element array 12 on one mounting plate 11 (left side) is in a 1-to-12 driving relationship, and a radiating element array 12 on the other mounting plate 11 (right side) includes two driving relationships: the 1-to-6 driving relationship and the 1-to-12 driving relationship. That is, N=6, M=6, and L=12. In this embodiment, N=M. In another embodiment, N≠L, and N≠M.

In a specific embodiment, the two radiating element arrays 12 whose radiated signals cover a same cell may each have a driving relationship. Each radiating element array 12 has a driving relationship, causing it easy to design a weight. For example, in one of the two radiating element arrays 12 whose radiated signals cover a same cell, every O radiating elements are connected to one signal channel, that is, there is a 1-to-O driving relationship. In the other of the two radiating element arrays 12, every P radiating elements are connected to one signal channel, that is, there is a 1-to-P driving relationship. In an embodiment, if O≠P, driving relationships of the two radiating element arrays 12 are different, thereby improving flexibility of signal channel arrangement. In another embodiment, if O=P, driving relationships of the two radiating element arrays 12 are the same, and same beam weights may be designed for the two radiating element arrays 12.

FIG. 22 is a diagram of mechanical downtilt of a V-shaped antenna according to an embodiment of this application. As shown in FIG. 22, in an embodiment, to improve performance of a V-shaped antenna 1, in this embodiment of this application, the V-shaped antenna 1 may further include a driving mechanism 19. The driving mechanism 19 is separately connected to two mounting plates 11. The driving mechanism 19 is configured to drive the mounting plates 11 to rotate about a mechanical downtilt rotation axis 191, and a mechanical downtilt rotation axis 191 of each mounting plate 11 is parallel to a corresponding mounting plate 11. In an embodiment, the mechanical downtilt rotation axis 191 may be located in a plane on which the mounting plate 11 is located, or the mechanical downtilt rotation axis 191 may be located outside the plane on which the mounting plate 11 is located. In this solution, a normal direction of a radiating element array 12 may be adjusted by adjusting mechanical downtilt of the mounting plate 11, to adjust a region covered by a signal of a radiating element and signal strength for different regions, thereby enriching an application scenario of a communication system.

To implement rotation of the mounting plate 11, the mounting plate 11 may be rotated and mounted relative to an antenna mounting kit 300.

In another embodiment, the driving mechanism 19 may be further connected to only one mounting plate 11, and is configured to drive the one mounting plate 11 to rotate about the mechanical downtilt rotation axis 191, to meet a specific application requirement of the V-shaped antenna 1.

In addition, in an embodiment, the driving mechanism 19 includes a first driving mechanism and a second driving mechanism. The first driving mechanism is connected to one mounting plate 11 of the V-shaped antenna 1, and is configured to drive the one mounting plate 11 to rotate about a mechanical downtilt rotation axis 191 of the mounting plate 11. The other driving mechanism is connected to the other mounting plate 11 of the V-shaped antenna 1, and is configured to drive the other mounting plate 11 to rotate about a mechanical downtilt rotation axis 191 of the other mounting plate. In this embodiment, mechanical downtilt of two mounting plates 11 of one V-shaped antenna 1 is decoupled. When the mechanical downtilt of one mounting plate 11 is adjusted, mechanical downtilt may be performed on the other mounting plate 11, or the other mounting plate may remain stationary, or mechanical downtilt angles or directions of the two mounting plates are different.

In an embodiment, one driving mechanism 19 may be further used to drive the two mounting plates 11 to perform mechanical downtilt, thereby simplifying a structure of the V-shaped antenna 1 and reducing costs of the V-shaped antenna 1.

In a specific embodiment, the mechanical downtilt rotation axis 191 is perpendicular to a center line extending along an axis of a mounting bracket 200. When the mounting plate 11 rotates about the mechanical downtilt rotation axis, it can be ensured that there is a specific position relationship between the mounting plate 11 and the mounting bracket 200, and the mounting plate 11 does not deflect along a direction of the mechanical downtilt rotation axis 191. In an embodiment, a mechanical downtilt rotation axis of the one mounting plate 11 is parallel to a first axis, and a mechanical downtilt rotation axis of the other mounting plate 11 is parallel to a second axis.

In a state in which the mounting plate 11 of the V-shaped antenna 1 is a square mounting plate 11, for example, the mounting plate 11 may be a rectangular mounting plate 11 or a square mounting plate 11. The mechanical downtilt rotation axis 191 is parallel to at least one side edge of the square mounting plate 11. For example, the mounting plates 11 are rectangular mounting plates 11, and a long edge of one of the two mounting plates 11 is parallel to a long edge of the other mounting plate 11, and is parallel to the center line extending along the axis of the mounting bracket 200. In this case, the mechanical downtilt rotation axis 191 is parallel to a short edge of the square mounting plate 11. Alternatively, the mechanical downtilt rotation axis 191 is parallel to a top edge or a bottom edge of the square mounting plate 11.

In a specific application state, mounting plates 11 on which two radiating element arrays 12 whose radiated signals cover a same cell are located remain parallel, where the radiated signals are driven by the driving mechanism 19. In this solution, signals in a cell can be kept to have specific uniformity, and a coverage area is large. In addition, based on an actual requirement, the mounting plates 11 on which the two radiating element arrays 12 whose radiated signals cover a same cell are located remain unparallel, where the radiated signals are driven by the driving mechanism 19, and there is a specific included angle between the mounting plates 11, so that signal coverage strength of some regions is improved in a targeted manner.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A communication system, comprising:
a mounting bracket; and
at least two antennas mounted on the mounting bracket around a periphery of the mounting bracket, wherein
the at least two antennas comprise at least one V-shaped antenna comprising two mounting plates, a radiating element array is mounted on a surface of a side that is of each mounting plate and that is away from the mounting bracket, and planes on which the two mounting plates are located intersect; a first mounting plate of the two mounting plates has a first axis, a second mounting plate has a second axis, and the first axis and the second axis are perpendicular to a center line extending along an axis of the mounting bracket; and a first included angle β exists between the first axis and the second axis, and the first included angle β is less than or equal to 150°.

2. The communication system according to claim 1, wherein a first area of the first mounting plate is same as a second area of the second mounting plate.

3. The communication system according to claim 1, wherein the two mounting plates are symmetrical about a first plane, and the center line extending along the axis of the mounting bracket is located on the first plane.

4. The communication system according to claim 1, wherein the at least one V-shaped antenna comprises a first V-shaped antenna, a second V-shaped antenna, and a third V-shaped antenna, wherein
the first V-shaped antenna comprises the first mounting plate and the second mounting plate, a first radiating element array is mounted on a surface of the first mounting plate, and a second radiating element array is mounted on a surface of the second mounting plate;
the second V-shaped antenna comprises a third mounting plate and a fourth mounting plate, a third radiating element array is mounted on a surface of the third mounting plate, and a fourth radiating element array is mounted on a surface of the fourth mounting plate; and
the third V-shaped antenna comprises a fifth mounting plate and a sixth mounting plate, a fifth radiating element array is mounted on a surface of the fifth mounting plate, and a sixth radiating element array is mounted on a surface of the sixth mounting plate.

5. The communication system according to claim 4, wherein the first V-shaped antenna, the second V-shaped antenna, and the third V-shaped antenna are evenly arranged on the periphery of the mounting bracket circumferentially.

6. The communication system according to claim 4, wherein a signal radiated by the second radiating element array and a signal radiated by the third radiating element array cover a first cell, a signal radiated by the fourth radiating element array and a signal radiated by the fifth radiating element array cover a second cell, and a signal radiated by the sixth radiating element array and a signal radiated by the first radiating element array cover a third cell.

7. The communication system according to claim 6, wherein the second mounting plate is adjacent to the third mounting plate, the fourth mounting plate is adjacent to the fifth mounting plate, and the sixth mounting plate is adjacent to the first mounting plate.

8. The communication system according to claim 6, wherein the second mounting plate is parallel to the third mounting plate, the fourth mounting plate is parallel to the fifth mounting plate, and the sixth mounting plate is parallel to the first mounting plate.

9. The communication system according to claim 1, wherein the at least one V-shaped antenna comprises a fourth V-shaped antenna and a fifth V-shaped antenna, wherein
the fourth V-shaped antenna comprises a seventh mounting plate and an eighth mounting plate, a seventh radiating element array is mounted on a surface of the seventh mounting plate, and an eighth radiating element array is mounted on a surface of the eighth mounting plate; and the fifth V-shaped antenna comprises a ninth mounting plate and a tenth mounting plate, a ninth radiating element array is mounted on a surface of the ninth mounting plate, and a tenth radiating element array is mounted on a surface of the tenth mounting plate; and
a signal radiated by the seventh radiating element array covers a fourth cell, a signal radiated by the eighth radiating element array and a signal radiated by the ninth radiating element array cover a fifth cell, and a signal radiated by the tenth radiating element array covers a sixth cell.

10. The communication system according to claim 6, wherein the at least one V-shaped antenna comprises a circuit module comprising a plurality of signal channels, each radiating element array comprises a plurality of radiating elements, and a signal channel is connected to at least one radiating element of the plurality of radiating elements; and
two radiating element arrays of which radiated signals cover a same cell are arranged in a same manner, and connection relationships between radiating elements in the two radiating element arrays and the signal channel are same.

11. The communication system according to claim 6, wherein the at least one V-shaped antenna comprises a circuit module comprising a plurality of signal channels, each radiating element array comprises a plurality of radiating elements, and a signal channel is connected to at least two radiating elements; and
two radiating element arrays of which radiated signals cover a same cell are arranged in an axisymmetric manner, and connection relationships between radiating elements in the two radiating element arrays and the signal channel are also axisymmetric.

12. The communication system according to claim 6, wherein the at least one V-shaped antenna comprises a circuit module comprising a plurality of signal channels, each radiating element array comprises a plurality of radiating elements, and a signal channel is connected to at least two radiating elements; and
two radiating element arrays of which radiated signals cover a same cell are arranged differently, and in a first radiating element arrays of the two radiating element arrays, every N radiating elements are connected to one signal channel; and in a second radiating element arrays of the two radiating element arrays, in a part of the plurality of radiating elements, every M radiating elements are connected to one signal channel, and in a part of the plurality of radiating elements, every L radiating elements are connected to one signal channel, wherein M≠L.

13. The communication system according to claim 6, wherein the at least one V-shaped antenna comprises a circuit module comprising a plurality of signal channels, each radiating element array comprises a plurality of radiating elements, and a signal channel is connected to at least two radiating elements; and
in a first radiating element array of two radiating element arrays of which radiated signals cover a same cell, every O radiating elements are connected to one signal channel; and in a second radiating element array of the two radiating element arrays, in a part of the plurality of radiating elements, every P radiating elements are connected to one signal channel, wherein O≠P.

14. The communication system according to claim 1, wherein the at least one V-shaped antenna comprises at least one driving mechanism separately connected to the two mounting plates, the at least one driving mechanism is configured to drive each of the two mounting plates to rotate about a corresponding mechanical down tilt rotation axis, and the corresponding mechanical down tilt rotation axis of each mounting plate is parallel to a corresponding mounting plate.

15. The communication system according to claim 14, wherein the at least one driving mechanism comprises a first driving mechanism and a second driving mechanism, wherein the first driving mechanism is connected to the first mounting plate, and is configured to drive the first mounting plate to rotate about a corresponding mechanical down tilt rotation axis of the first mounting plate, and the second driving mechanism is connected to the second mounting plate, and is configured to drive the second mounting plate to rotate about a corresponding mechanical down tilt rotation axis of the second mounting plate.

16. The communication system according to claim 14, wherein the corresponding mechanical down tilt rotation axis is perpendicular to the center line extending along the axis of the mounting bracket.

17. The communication system according to claim 14, wherein each of the two mounting plates is a corresponding square mounting plate, and the corresponding mechanical down tilt rotation axis is parallel to at least one side edge of the corresponding square mounting plate.

18. The communication system according to claim 14, wherein mounting plates on which two radiating element arrays of which radiated signals cover a same cell are located remain parallel.

19. The communication system according to claim 1, wherein the at least one V-shaped antenna comprises a circuit module connected to the radiating element array, and the circuit module is mounted on sides that are of the two mounting plates and that are away from the radiating element arrays.

20. At least one V-shaped antenna, mounted on a mounting bracket, comprising:
two mounting plates, a radiating element array is mounted on a surface of a side that is of each mounting plate and that is away from the mounting bracket, and planes on which the two mounting plates are located intersect; a first mounting plates of the two mounting plates has a first axis, a second mounting plate has a second axis, and the first axis and the second axis are perpendicular to a center line extending along an axis of the mounting bracket; and a first included angle β exists between the first axis and the second axis, and the first included angle β is less than or equal to 150°.
